(19) United States
(12) Patent Application Publication
(10) Pub. No.: US 2017/0109427 A1
(43) Pub. Date: Apr. 20, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Daisuke Izumi, Utsunomiya-shi (JP); Yusuke Mitarai, Tokyo (JP)

(21) Appl. No.: 15/290,573

(22) Filed: Oct. 11, 2016

(30) Foreign Application Priority Data
Oct. 15, 2015 (JP) 2015-204016

(51) Int. Cl. G06F 17/30; G06N 99/00; G06T 7/00; G06K 9/46; G06K 9/62; G06N 7/00; G06F 17/16

(52) U.S. Cl. CPC G06F 17/30598; G06N 7/005; G06N 99/005; G06F 17/16; G06K 9/4604; G06K 9/6218; G06T 7/001

(57) ABSTRACT

An apparatus includes an extraction unit configured to extract a feature amount from each of a plurality of pieces of input data, a calculation unit configured to calculate, based on an identification model for identifying to which one of a plurality of labels each of the plurality of pieces of input data belongs, which is generated using the feature amount, a likelihood indicating how likely each of the plurality of pieces of input data belongs to the labels, and a presenting unit configured to present attribute information about the input data based on the feature amount and the likelihood.

### BACKGROUND OF THE INVENTION

Field of the Invention

Aspects of the present invention relate to an information processing apparatus, an information processing method, and a storage medium.

Description of the Related Art

In Japanese Patent Application Laid-Open No. 2010-54346, a neural network is used to calculate an identification criterion for classifying a plurality of types of defects. In Japanese Patent Application Laid-Open No. 2010-54346, data that indicates a type of a defect is automatically extracted on a space constituted by two feature amounts determined by a user, and the user instructs a defect type with respect to the extracted data to update the identification criterion.

In Japanese Patent Application Laid-Open No. 2010-54346, the identification criterion is calculated based on data to which a label of a few defect types is given, and the data distribution on the feature space constituted by the two feature amounts determined by the user and the identification criterion for classifying defects in the feature space are presented to the user. However, when a data distribution and an identification criterion are presented to the user, the user can understand a space of up to three dimensions. Thus, in a case where an identification criterion is calculated using four or more feature amounts, there arises a situation that a data distribution on the feature space cannot be displayed.

### SUMMARY OF THE INVENTION

According to an aspect of the present invention, an apparatus includes an extraction unit configured to extract a feature amount from each of a plurality of pieces of input data, a calculation unit configured to calculate, based on an identification model for identifying to which one of a plurality of labels each of the plurality of pieces of input data belongs, which is generated using the feature amount, a likelihood indicating how likely each of the plurality of pieces of input data belongs to the labels, and a presenting unit configured to present attribute information about the input data based on the feature amount and the likelihood.

Further features of aspects of the present invention will become apparent from the following description of exemplary embodiments with reference to the attached drawings.

### BRIEF DESCRIPTION OF THE DRAWINGS

FIG. 1 is a diagram illustrating an example of a presentation result according to a first exemplary embodiment of aspects of the present invention.

FIG. 2 is a block diagram illustrating an example of a configuration of an information processing apparatus according to the first exemplary embodiment of aspects of the present invention.

FIG. 3 is a flow chart illustrating a processing method according to the first exemplary embodiment of aspects of the present invention.

FIG. 4 is a table illustrating an input data recording method according to the first exemplary embodiment of aspects of the present invention.

FIG. 5 is a table illustrating a likelihood recording method according to the first exemplary embodiment of aspects of the present invention.

FIG. 6 is a block diagram illustrating an example of a configuration of an information processing apparatus according to a second exemplary embodiment of aspects of the present invention.

FIG. 7 is a flow chart illustrating a processing method according to the second exemplary embodiment of aspects of the present invention.

FIG. 8 is a diagram illustrating a clustering result according to the second exemplary embodiment of aspects of the present invention.

FIG. 9 is a block diagram illustrating an example of a configuration of an information processing apparatus according to a third exemplary embodiment of aspects of the present invention.

FIG. 10 is a flow chart illustrating a processing method according to the third exemplary embodiment of aspects of the present invention.

FIGS. 11A and 11B are diagrams each illustrating a clustering result according to the third exemplary embodiment of aspects of the present invention.

### DESCRIPTION OF THE EMBODIMENTS

Various exemplary embodiments, features, and aspects of the invention will be described in detail below with reference to the drawings.

In a first exemplary embodiment of aspects of the present invention, images of a specific inspection target object are captured, and whether the inspection target object is normal is identified based on the captured images. In the present exemplary embodiment, feature amounts serving as elements for the identification between normal and abnormal are calculated from the images. A likelihood indicating how likely the inspection target object is to be normal, which is to be a criterion for the identification between normal and abnormal, is calculated based on the feature amounts calculated from a plurality of normal images and a plurality of abnormal images.

Meanwhile, when a data distribution on a feature space is visualized, in a case where only the data distribution on the feature space is visualized, the likelihood of data that is an identification criterion is not taken into consideration. Thus, although two pieces of neighboring data in the visualized result may have completely different likelihoods, the user may erroneously determine that pieces of neighboring data in the visualized result have close likelihoods. In view of the foregoing, in the present exemplary embodiment, a data distribution on a feature space is visualized while taking the likelihood of data, in addition to a distance relationship on the feature space, into consideration. In this way, the data distribution on the feature space and the identification performance based on the identification criterion can simultaneously be presented.

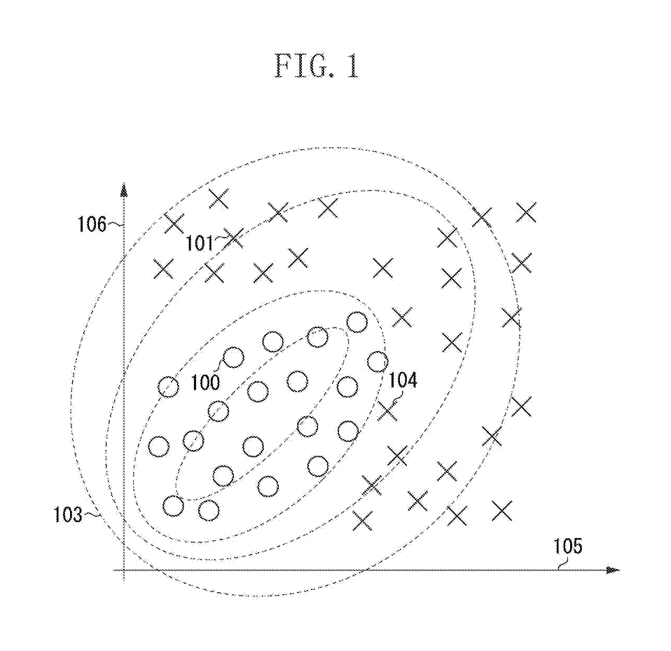

FIG. 1 is a diagram illustrating an example of a presentation result by an information processing apparatus according to the present exemplary embodiment. The information processing apparatus is for simultaneously visualizing a data distribution on a feature space constituted by a plurality of feature amounts, and a likelihood that is an identification criterion for the identification between normal and abnormal. In FIG. 1, axes 105 and 106 of a visualized space indicate bases for displaying a visualized result. Details of the bases will be described below. Further, distances between respective pieces of data reflect the positional relationships on the feature space. A contour line 103 indicates positional coordinates of the same likelihood. The information processing apparatus displays a presentation result as illustrated in FIG. 1, thereby simultaneously presenting the positional relationships between normal data 100 and abnormal data 101 on the feature space, and the likelihoods. On the other hand, the technique discussed in Japanese Patent Application Laid-Open No. 2010-54346 displays a feature space and an identification criterion on the feature space, so that, when the feature space exceeds the number of dimensions that can directly be presented, the feature space cannot be displayed.

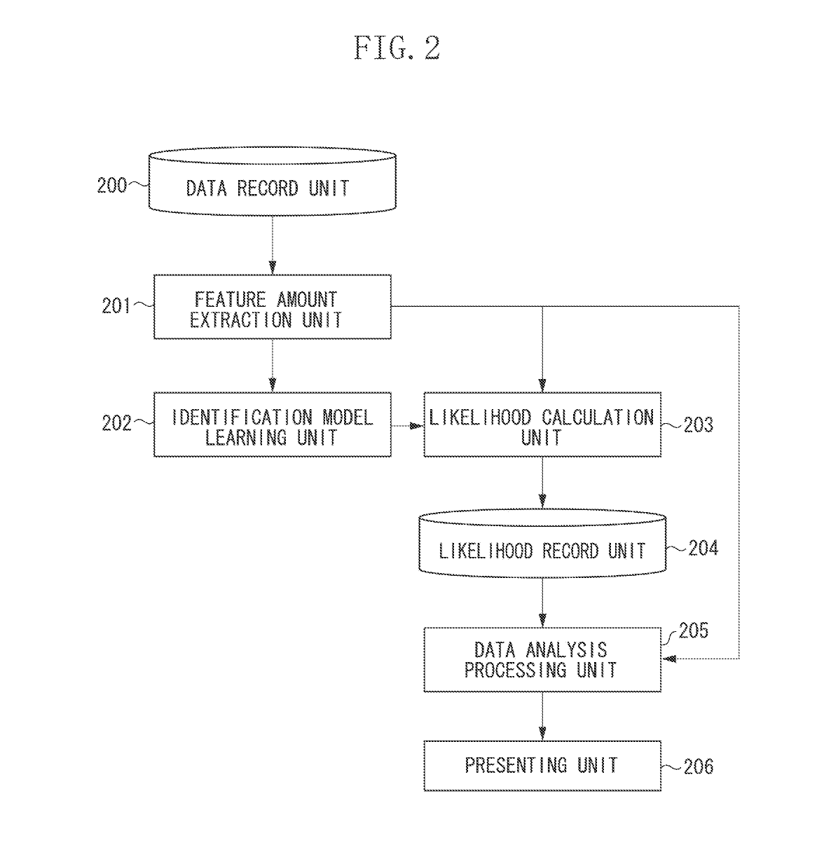

FIG. 2 is a block diagram illustrating an example of a configuration of the information processing apparatus according to the present exemplary embodiment. The information processing apparatus includes a data record unit 200, a feature amount extraction unit 201, an identification model learning unit 202, a likelihood calculation unit 203, a likelihood record unit 204, a data analysis processing unit 205, and a presenting unit 206.

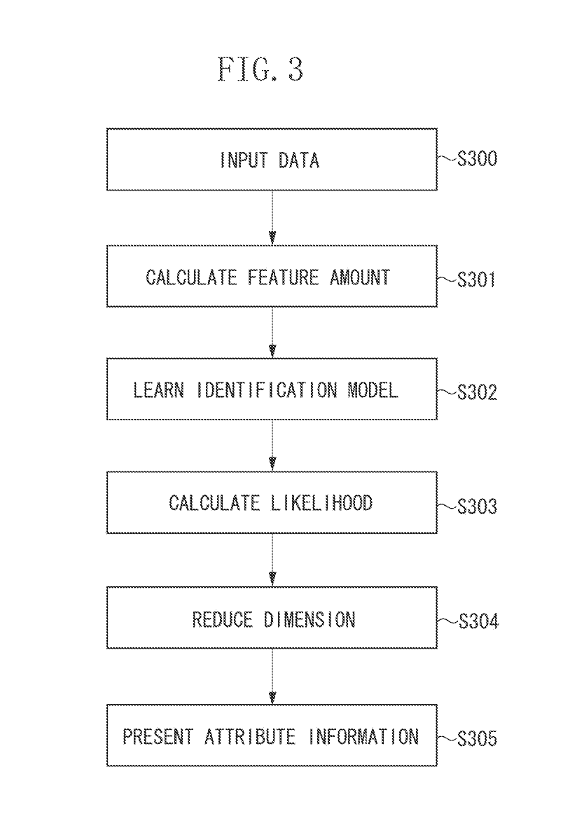

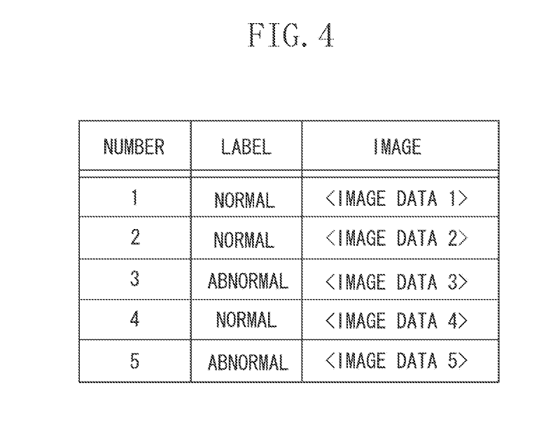

FIG. 3 is a flow chart illustrating a method of information processing performed by the information processing apparatus according to the present exemplary embodiment. First, in step S300, the data record unit 200 stores, in association with image numbers, a plurality of pieces of image data obtained by capturing images of normal inspection target objects and abnormal inspection target objects, as illustrated in FIG. 4. At this time, the data record unit 200 stores each of the plurality of pieces of image data in association with, a normal label indicating a piece of image data obtained by capturing a normal inspection target object, or an abnormal label indicating a piece of image data obtained by capturing an abnormal inspection target object. The feature amount extraction unit 201, which is a means for extracting a feature amount, reads image data as input data from the data record unit 200. The present exemplary embodiment is described while taking the images as an example. However, any data exhibiting different tendencies between a normal inspection target object and an abnormal inspection target object may be used. Examples of such data include acoustic data and data obtained by other sensors.

Next, in step S301, the feature amount extraction unit 201 calculates a feature amount that is to be an element for the identification between normal and abnormal, with respect to each of the pieces of image data stored in the data record unit 200. While there are various examples of a feature amount, statistics such as mean, variance, skewness, kurtosis, mode, entropy, etc. of luminance values of the images are used in the present exemplary embodiment. Besides the foregoing examples, a texture feature amount using a co-occurrence matrix, a local feature amount using scale-invariant feature transform (SIFT) can be used. The feature amount extraction unit 201 extracts an N-dimensional feature amount with respect to all of the pieces of the normal image data and the abnormal image data that are stored in the data record unit 200.

Next, in step S302, the identification model learning unit 202, which is a means for learning an identification model, calculates parameters of an identification model by use of a given identification model for the separation between normal data and abnormal data and the feature amounts calculated by the feature amount extraction unit 201. More specifically, the identification model learning unit 202 learns (generates), using the feature amounts, an identification model for identifying to which one of the normal label and the abnormal label each of the plurality of pieces of image data belongs. In the present exemplary embodiment, the Mahalanobis distance is used as the identification model. The identification model learning unit 202 calculates the mean and the variance-covariance matrix using the feature amounts extracted from the pieces of image data stored in association with the normal label in the data record unit 200. In this way, the identification can be made in such a manner that the smaller a Mahalanobis distance calculated using a feature amount extracted from data of an arbitrary image, the more likely the arbitrary image is normal. On the other hand, the identification can be made in such a manner that the greater a Mahalanobis distance calculated using a feature amount extracted from data of an arbitrary image, the more likely the arbitrary image is abnormal. An N-dimensional feature amount extracted by the feature amount extraction unit 201 from a piece of image data stored in the data record unit 200 is denoted by cᵢ (i is the image number). A mean value and a variance-covariance matrix that are calculated using only the feature amounts extracted from the pieces of image data stored in association with the normal labels are denoted by μ and σ, respectively. The identification model learning unit 202 calculates the mean value μ and the variance-covariance matrix σ as the parameters of the identification model. While the Mahalanobis distance is used as the identification model in the present exemplary embodiment, any identification model by which the identification between normal and abnormal can be made may be used. Examples of such an identification model include one-class support vector machines (SVM) and k-nearest neighbor.

Next, in step S303, the likelihood calculation unit 203, which is a means for calculating a likelihood, calculates a likelihood L(cᵢ), which indicates how likely an image stored in the data record unit 200 is to be normal, by use of the identification model calculated by the identification model learning unit 202. More specifically, first, the likelihood calculation unit 203 calculates a Mahalanobis distance D(cᵢ) for the N-dimensional feature amount cᵢ using the mean value μ and the variance-covariance matrix σ that have been calculated by the identification model learning unit 202 using only the feature amounts extracted from the pieces of image data stored in association with the normal labels, as specified by formula (1) below. In formula (1), T represents the transpose of the matrix, and σ¹ represents the inverse of the variance-covariance matrix o.

[Formula 1]

D(cᵢ)=\sqrt{(cᵢ−μ)^{T}σ⁻¹(cᵢ−μ)} (1)

Next, the likelihood calculation unit 203 calculates the likelihood L(cᵢ) using the Mahalanobis distance D(cᵢ) as specified by formula (2) below. In formula (2), Z represents a normalization coefficient. In other words, the likelihood calculation unit 203 calculates, with respect to each of the plurality of pieces of data, the likelihood L(cᵢ) that indicates how likely each of the plurality of pieces of data belongs to the normal label, which is a first label, using the feature amount cᵢ and the mean value μ of the feature amounts extracted from the data belonging to the normal label that is the first label.

$$\begin{matrix}[ Formula 2 ] & \\ L ( {c}_{i} ) = \frac{1}{Z} exp ( - D ( {c}_{i} ) ) & ( 2 )\end{matrix}$$

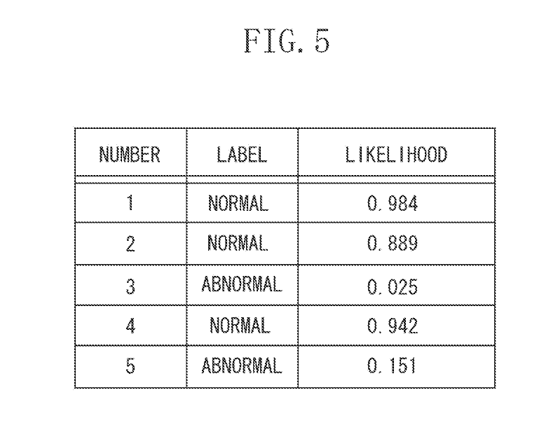

Next, as illustrated in FIG. 5, the likelihood record unit 204 stores the likelihood L(cᵢ) calculated for the feature amount cᵢ by the feature amount extraction unit 201, in association with the image number used by the data record unit 200 in FIG. 4. While the likelihood record unit 204 stores the likelihood L(cᵢ) separately from the data record unit 200, the likelihood L(cᵢ) may be recorded in any form as long as the likelihood L(cᵢ) is stored in such a manner that the feature amount cᵢ is associated with the likelihood L(cᵢ).

Next, in step S304, if the feature amount cᵢ and the likelihood L(cᵢ) are data having greater dimensions than three dimensions, the data analysis processing unit 205, which is a means for processing data analysis, reduces the number of dimensions and calculates positional coordinates on a space of three or fewer dimensions. More specifically, the data analysis processing unit 205 calculates positional coordinates of each of the plurality of pieces of data on the visualized space in order to simultaneously visualize the relationship between the pieces of data on the feature space and the likelihood L(cᵢ) that is the identification criterion. For example, the data analysis processing unit 205 calculates the positional coordinates of the data on the visualized space by use of a unified vector uᵢ=[cᵢ, L(cᵢ)] obtained by combining the feature amount cᵢ calculated by the feature amount extraction unit 201 and the likelihood L(cᵢ) stored in the likelihood record unit 204.

For example, the data analysis processing unit 205 performs the visualization so that an index S, which is referred to as “stress” and specified by formula (3) below, is minimized.

$$\begin{matrix}[ Formula 3 ] & \\ S = \sqrt{\frac{{Σ}_{i = 1}^{i = M} {{Σ}_{j = i + 1}^{j = M} ( {d}_{ij} - d {1}_{ij} )}^{2}}{{Σ}_{i = 1}^{i = M} {Σ}_{j = i + 1}^{j = M} {d}_{ij}^{2}}} & ( 3 )\end{matrix}$$

In formula (3), M represents the number of pieces of data to be visualized. As specified by formula (4) below, d1ᵢⱼ represents the distance between the i-th data and the j-th data on the visualized space.

[Formula 4]

d1ᵢⱼ=\sqrt{(vᵢ−vⱼ)^{T}(vᵢ−vⱼ)} (4)

As illustrated in FIG. 1, the data analysis processing unit 205 determines the visualized space as a two-dimensional space and calculates the distance d1ᵢⱼ between the i-th data and the j-th data on the visualized space using the Euclidean distance. In the present exemplary embodiment, the coordinates of the i-th data on the visualized space are vᵢ=[xᵢ, yᵢ]^{T}, and the coordinates of the j-th data on the visualized space are vⱼ=[xⱼ, yⱼ]^{T}. In this case, the axis 105 of the visualized space is the coordinate axis for the positions of xᵢ and xⱼ, and the axis 106 of the visualized space is the coordinate axis for the positions of yᵢ and yⱼ.

Further, dᵢⱼ represents the dissimilarity between the i-th data and the j-th data. In general, the dissimilarity dᵢⱼ is calculated using the positional relationship on the feature space. Thus, the dissimilarity dᵢⱼ is calculated using the feature amount cᵢ of the i-th data and the feature amount cⱼ of the j-th data. However, if the dissimilarity dᵢⱼ is calculated using only the positional relationship on the feature space, the positional relationship between the pieces of data that is expressed on the visualized space does not reflect the likelihood L(cᵢ) that is the identification criterion. Thus, the data analysis processing unit 205 takes the likelihood L(cᵢ) that is the identification criterion into consideration when calculating the dissimilarity dᵢ In the present exemplary embodiment, the data analysis processing unit 205 calculates the dissimilarity dᵢⱼ using the Euclidean distance using the unified vector uᵢ=[cᵢ, L(cᵢ)] obtained by unifying the likelihood L(cᵢ) and the feature amount cᵢ, as specified by formula (5) below.

[Formula 5]

dᵢⱼ=\sqrt{(uᵢ−uⱼ)^{T}(uᵢ−uⱼ)} (5)

As the foregoing describes, the data analysis processing unit 205 calculates the coordinates vᵢ and vⱼ of data on the visualized space so that the index S as specified by the formula (3) above is minimized. More specifically, the data analysis processing unit 205 calculates the positional coordinates vᵢ and vⱼ of each of the plurality of pieces of data so that an error between the distance between two pieces of the data on the feature amount cᵢ and the likelihood L(cᵢ), and the distance between the positional coordinates of two pieces of the data on the space is minimized. At this time, the data analysis processing unit 205 calculates the dissimilarity dᵢⱼ between the data using the unified vectors uᵢ and uⱼ, whereby the positional relationship between the data on the likelihood L(cᵢ) that is the identification criterion can be simultaneously reflected on the positional relationship between the data on the visualized space.

While the distance d1ᵢⱼ between the two pieces of data on the visualized space and the dissimilarity dᵢⱼ are calculated using the Euclidean distance in the present exemplary embodiment, the Mahalanobis distance, the city block distance, or the Pearson distance may be used as long as the relationship between the two pieces of data can be defined. Further, any other index may be used as the index S of formula (3) above.

Further, while the unified vectors uᵢ and uⱼ are used to reflect the influence of the likelihood L(cᵢ) that is the identification criterion in the positional relationship between the data on the visualized space in the present exemplary embodiment, the present invention is not limited thereto. The index S of formula (3) above may be defined as an index that provides the influence of the likelihood L(cᵢ) that is the identification criterion. In this case, for example, an index S1 of formula (6) below may be used in place of the index S of formula (3) above.

$$\begin{matrix} [ Formula 6 ] & \\ S 1 = \sqrt{\frac{{Σ}_{i = 1}^{i = M} {{Σ}_{j = i + 1}^{j = M} ( d {2}_{ij} - d {1}_{ij} )}^{2}}{{Σ}_{i = 1}^{M} {Σ}_{j = i + 1}^{j = M} d {2}_{ij}^{2}}} + α \sqrt{\frac{{Σ}_{i = 1}^{i = M} {{Σ}_{j = i + 1}^{j = M} ( {p}_{ij} - d {1}_{ij} )}^{2}}{{Σ}_{i = 1}^{M} {Σ}_{j = i + 1}^{j = M} {p}_{ij}}} & ( 6 )\end{matrix}$$

In formula (6), d2ᵢ is the dissimilarity between the feature amounts cᵢ and cⱼ of the two pieces of data and is equal to the dissimilarity dᵢⱼ in the case where uᵢ=cᵢ. Further, pᵢⱼ is the dissimilarity between the likelihoods L(cᵢ) and L(cⱼ) of the two pieces of data and is obtained by pᵢⱼ={L(cᵢ)−L(cⱼ)}². The dissimilarities d2ᵢⱼ and pᵢⱼ can be calculated using the Mahalanobis distance, Pearson distance, etc. Further, α is a parameter that determines the intensity of the influence of the dissimilarity on the feature space and the dissimilarity obtained using the Mahalanobis distance. As α becomes close to 0, the influences of the likelihoods L(cᵢ) and L(cⱼ) decrease, and the dissimilarity d2ᵢⱼ on the feature space is maintained. On the other hand, as a increases, the dissimilarity pᵢⱼ between the likelihoods L(cᵢ) and L(cⱼ) is maintained on the visualized space.

While the positional relationship between data on the visualized space is determined by the method described above in the present exemplary embodiment, the method for the determination is not limited to the method described above. Any method that can reduce the number of dimensions may be used, such as principal component analysis, Fisher's discriminant analysis, etc.

Next, in step S305, the presenting unit 206, which is a presentation means, presents attribute information including the positional relationship between the data and the likelihood L(cᵢ) that is the identification criterion using the coordinates vᵢ of the data on the visualized space that are calculated by the data analysis processing unit 205. More specifically, the presenting unit 206 displays the positions of the positional coordinates of the respective pieces of the normal data 100 and the abnormal data 101 on the two-dimensional space, as illustrated in FIG. 1. Further, the presenting unit 206 displays the contour line 103 along the positional coordinates of the same likelihood L(cᵢ) that is the identification criterion.

In order to display the contour line 103 specified in FIG. 1, the presenting unit 206 is to join points of the same likelihood L(cᵢ). Meanwhile, the coordinates vᵢ of data points that are calculated by the data analysis processing unit 205 do not exist at regular intervals, so the presenting unit 206 is to interpolate points of the same likelihood L(cᵢ). Thus, the presenting unit 206 performs interpolation of the likelihood L(cᵢ) by cubic interpolation using the likelihood L(cᵢ) of the coordinates vᵢ of data points that are calculated by the data analysis processing unit 205, and joins points of the same likelihood L(cᵢ) on the visualized space, thereby displaying the contour line 103 specified in FIG. 1. While the interpolation of points of the same likelihood L(cᵢ) on the visualized space is performed using bicubic interpolation in the present exemplary embodiment, any method that enables such interpolation may be used, such as bilinear interpolation, etc.

As the foregoing describes, in the present exemplary embodiment, the likelihood L(cᵢ), which is the identification criterion for the identification between normal and abnormal, and the feature amount that is the information to be an element for the identification between normal and abnormal can be presented simultaneously. While the identification between normal and abnormal in the one-class identification situation is described as an example in the present exemplary embodiment, an exemplary embodiment of aspects of the present invention is also applicable to a binary or multiclass identification situation. For example, in the case of a multiclass identification situation, the likelihood L(cᵢ) is calculated for every one of the classes. Thus, the unified vector uᵢ can be realized by combining the likelihoods L1(cᵢ) to Ln(cᵢ) for all the classes to obtain uᵢ=[cᵢ, L1(cᵢ), L2(cᵢ), . . . , Ln(cᵢ)]. Further, in a case where a limitation by the likelihood is to be set, the dissimilarity between the likelihood vectors may be calculated using the Euclidean distance, Mahalanobis distance, Pearson distance, etc.

An information processing apparatus according to a second exemplary embodiment of aspects of the present invention will be described below. In the first exemplary embodiment, the information processing apparatus extracts the feature amount cᵢ from target data and learns the identification model for the identification between normal and abnormal by use of the extracted feature amount cᵢ In the present exemplary embodiment, the case where input data contains data given a low-reliability normal or abnormal label will be considered. If data with an incorrect label is used in identification model learning, an appropriate identification boundary between normal and abnormal cannot be acquired, and the identification accuracy may decrease. Thus, the user corrects the given label to regive an appropriate label. By performing the identification model leaning using the regiven label, the identification model can be learned with higher identification performance.

Thus, in the present exemplary embodiment, data that may have an incorrect label is presented to the user using the feature amount cᵢ and the likelihood L(cᵢ) to prompt the user to give an appropriate label. At this time, not only the data that may have an incorrect label but also useful data for the correction of other labels may be presented to the user so that an appropriate label can be given. While the two types of labels that are the normal label and the abnormal label are used in the present exemplary embodiment, an exemplary embodiment of aspects of the present invention is also applicable to a case where a plurality of other labels is given. Points in which the present exemplary embodiment is different from the first exemplary embodiment will be described below.

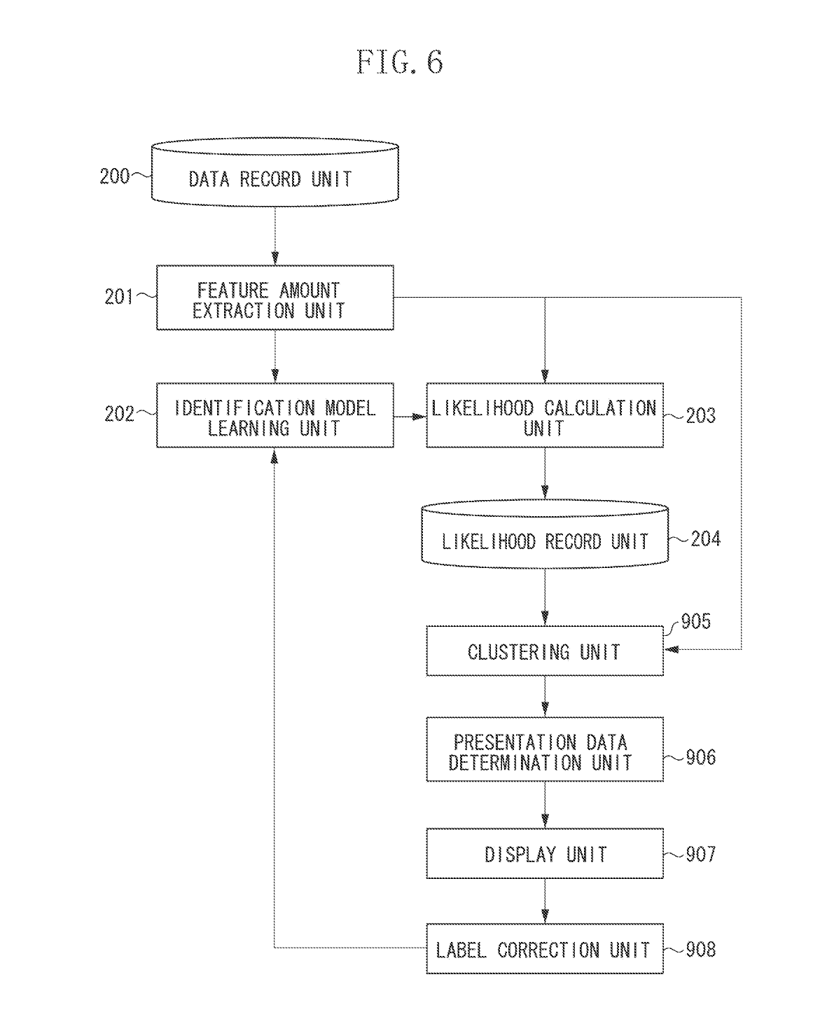

FIG. 6 is a block diagram illustrating an example of a configuration of the information processing apparatus according to a second exemplary embodiment of aspects of the present invention. The information processing apparatus includes a data record unit 200, a feature amount extraction unit 201, an identification model learning unit 202, a likelihood calculation unit 203, a likelihood record unit 204, a clustering unit 905, a presentation data determination unit 906, a display unit 907, and a label correction unit 908. The data record unit 200, the feature amount extraction unit 201, the identification model learning unit 202, the likelihood calculation unit 203, and the likelihood record unit 204 are similar to those in the first exemplary embodiment (FIG. 2).

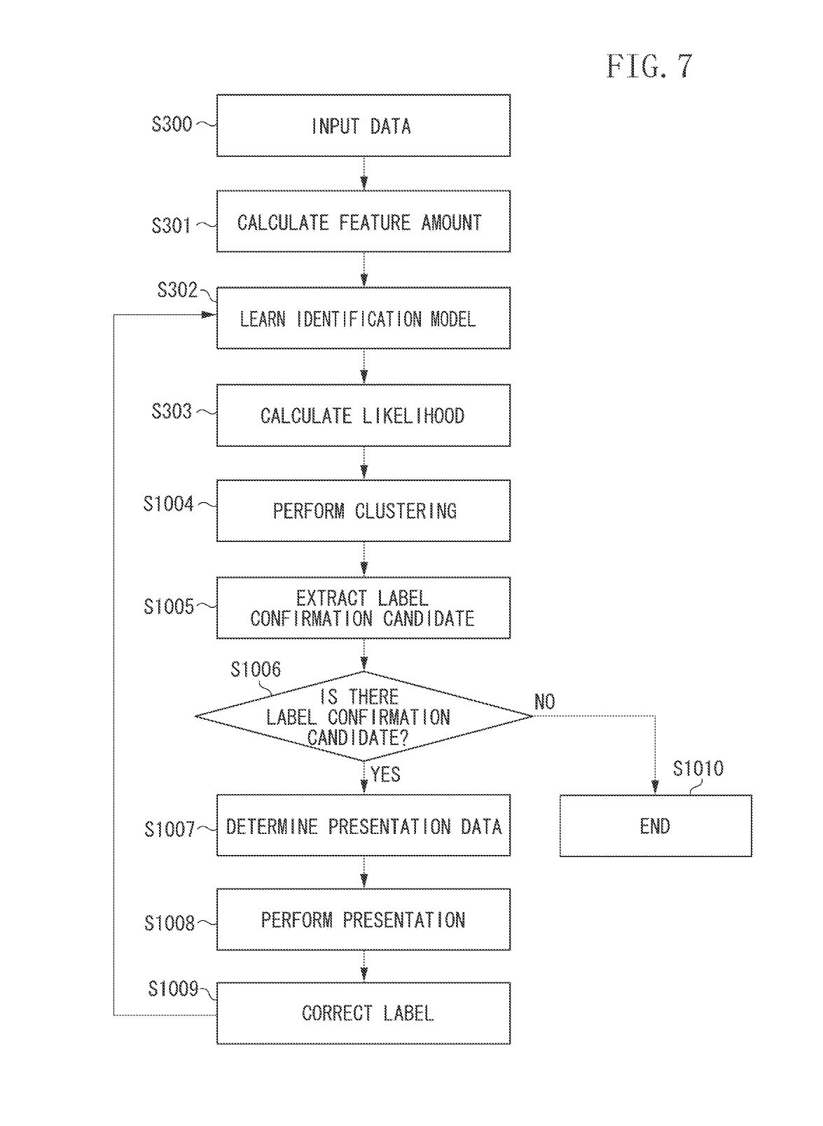

FIG. 7 is a flow chart illustrating a method of information processing performed by the information processing apparatus according to the present exemplary embodiment. In steps S300 to S303, the information processing apparatus performs processing similar to those in the first exemplary embodiment (FIG. 3). More specifically, in step S300, the feature amount extraction unit 201 inputs data stored in the data record unit 200. Next, in step S301, the feature amount extraction unit 201 calculates a feature amount cᵢ for data stored in the data record unit 200. Next, in step S302, the identification model learning unit 202 learns using the calculated feature amount cᵢ an identification model for the identification between normal and abnormal. Next, in step S303, the likelihood calculation unit 203 calculates using the identification model a likelihood L(cᵢ) for the feature amount cᵢ calculated by the feature amount extraction unit 201. The likelihood record unit 204 stores the likelihood L(cᵢ).

Next, in step S1004, the clustering unit 905, which is a clustering means, calculates positional coordinates of each of a plurality of pieces of data on a space based on the feature amount cᵢ and the likelihood L(cᵢ), as in the data analysis processing unit 205 illustrated in FIG. 2. Next, the clustering unit 905 performs data clustering using the feature amount cᵢ calculated by the feature amount extraction unit 901 and the likelihood L(cᵢ) stored in the likelihood record unit 904. For example, the clustering unit 905 classifies the plurality of pieces of data into predetermined k pieces of clusters B1 to Bk. More specifically, the clustering unit 905 determines the clusters B1 to Bk to which all the pieces of data belong so that an error between the center of gravity wᵢ of the cluster Bᵢ and the unified vector uⱼ contained in the cluster Bᵢ, as specified by formula (7) below, is minimized.

$$\begin{matrix}[ Formula 7 ] & \\ min {\sum }_{i = 1}^{k} {\sum }_{{c}_{j} ∈ {B}_{i}} {‖ {u}_{j} - {w}_{i} ‖}^{2} & ( 7 )\end{matrix}$$

As in the first exemplary embodiment, the unified vector uⱼ is a vector obtained by combining the feature amount cⱼ and the likelihood L(cⱼ), and uⱼ=[cⱼ, L(cⱼ)]. In this way, the feature amount cⱼ and the likelihood L(cⱼ) obtained using the identification model can be reflected in the clustering result.

The number of clusters k may be predetermined by the user, or data may be displayed to prompt the user to input the number of clusters k as in the first exemplary embodiment. Further, the number of clusters k may be determined by an x-means method in which the number of clusters k is determined using the Bayesian information criterion (BIC), or by any other methods. Further, besides the foregoing clustering method, any other methods may be used such as a hierarchical clustering method, etc.

Next, in steps S1005 to S1007, the presentation data determination unit 906, which is a means for determining presentation data, determines data the label of which is to be reconfirmed by the user, using the clusters B1 to Bk calculated by the clustering unit 905. First, in step S1005, the presentation data determination unit 906 extracts data with a low-reliability label as a label confirmation candidate. In order to extract low-reliability data, the presentation data determination unit 906 is to determine what data each of the clusters B1 to Bk of the clustering result contains. Thus, the presentation data determination unit 906 assigns labels that occur most frequently in the clusters B1 to Bk, respectively, as labels of the clusters B1 to Bk, respectively. Then, the presentation data determination unit 906 extracts data having a different label from the labels assigned to the respective clusters B1 to Bk as low-reliability data.

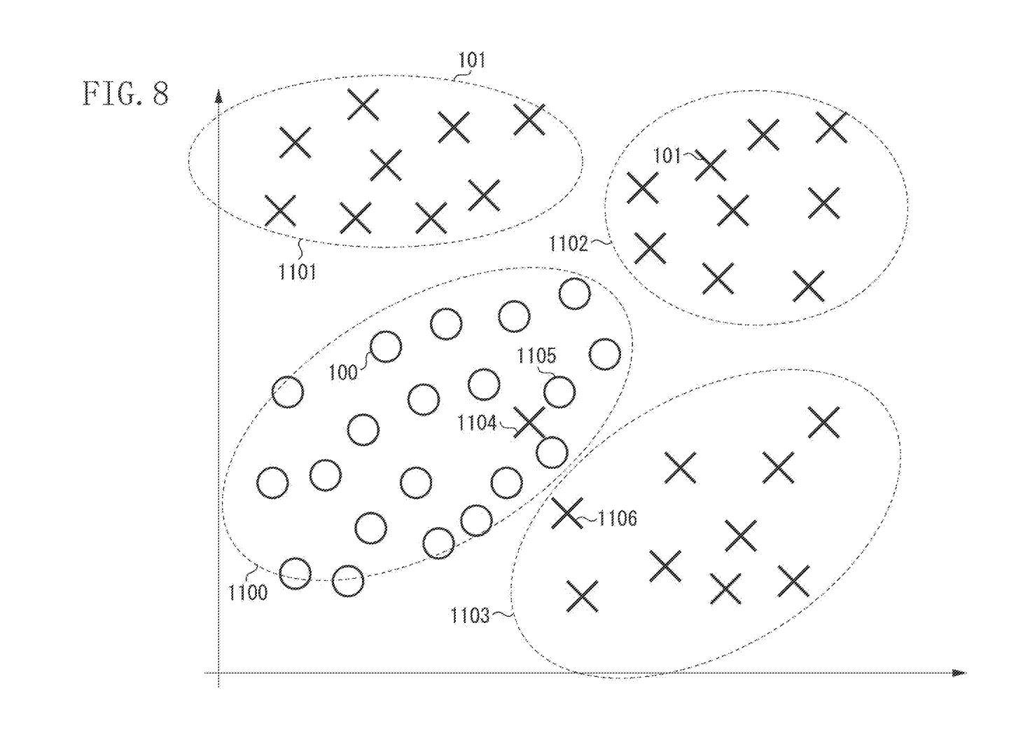

FIG. 8 is a diagram illustrating an example of a clustering result. The clustering unit 905 classifies, for example, a plurality of pieces of data into a plurality of clusters 1100 to 1103. The presentation data determination unit 906, for example, assigns a normal label to the cluster 1100, which contains a large number of pieces of normal data 100, and assigns an abnormal label to the clusters 1101, 1102 and 1103, each of which contains a large number of pieces of abnormal data 101. At this time, the cluster 1100 assigned the normal label contains a few pieces of abnormal data 1104. The presentation data determination unit 906 extracts such a few pieces of abnormal data 1104 as a label confirmation candidate. In other words, the presentation data determination unit 906 extracts as a label confirmation candidate the data 1104 belonging to the abnormal label having a smaller number of pieces of data than other normal labels, among the pieces of data belonging to the cluster 1100.

Next, in step S1006, the presentation data determination unit 906 determines whether there is a label confirmation candidate extracted in step S1005. If there is a label confirmation candidate (YES in step S1006), the processing proceeds to step S1007. On the other hand, if there is no label confirmation candidate (NO in step S1006), the processing proceeds to step S1010, and the processing illustrated in FIG. 7 is ended.

In step S1007, the presentation data determination unit 906 determines as presentation data the abnormal data 1104 extracted as a label confirmation candidate in step S1005. Meanwhile, when the abnormal data 1104 alone is presented to the user, it is difficult for the user to judge a label that should be given to the abnormal data 1104. Thus, simultaneously present data belonging to the current cluster and data belonging to a neighborhood cluster in addition to the abnormal data 1104 being a label confirmation candidate is performed. For example, the presentation data determination unit 906 determines normal data 1105 located in the neighborhood of the abnormal data 1104, abnormal data 1106 belonging to the cluster 1103 of the abnormal label that is located in the neighborhood of the cluster 1100 to which the abnormal data 1104 belongs, etc., as presentation data.

In the search for neighborhood data, the presentation data determination unit 906 does not search for neighborhood data on the feature space but searches for neighborhood data with the feature space and the likelihood taken into consideration, whereby data determined by the learned identification model as being located in the neighborhood can be presented. By presenting the neighborhood data together with the abnormal data 1104 being the label confirmation candidate, it becomes possible to prompt the user to input a more appropriate label.

Next, in step S1008, the display unit 907, which is a presenting means, displays (presents) to the user the positions of the positional coordinates of the presentation data containing the label confirmation candidate data determined by the presentation data determination unit 906 on the space.

Next, in step S1009, the user performs reconfirmation of the label based on the display on the display unit 907, and the label correction unit 908, which is a means for correcting a label, corrects the label of the label confirmation candidate data based on an instruction from the user. If an instruction is given to correct the label to which the presentation data displayed by the display unit 907 belongs, the label correction unit 908 corrects the label to which the presentation data belongs.

Thereafter, the information processing apparatus repeats step S302 and subsequent steps using the corrected label. In step S302, the identification model learning unit 202 relearns the identification model using the data containing the presentation data of the label corrected by the label correction unit 908, whereby the identification model can be learned more appropriately.

As the foregoing describes, in the present exemplary embodiment, data with a low-reliability label can be extracted with the likelihood L(cᵢ) that is the identification criterion taken into consideration, and a label confirmation candidate can be presented to the user.

An information processing apparatus according to a third exemplary embodiment of aspects of the present invention will be described below. In the first exemplary embodiment, the information processing apparatus extracts the feature amount cᵢ from target data and learns the identification model for the identification between normal and abnormal by use of the extracted feature amount cᵢ. Then, the information processing apparatus calculates the likelihood L(cᵢ) of the data using the identification model and simultaneously displays the data distribution and the contour line 103 of the likelihood L(cᵢ) on the feature space. The present exemplary embodiment will consider a case where a label given to input data is reliable but the number of pieces of data is insufficient. An example is a state in which a plurality of types of abnormal patterns exists in abnormal data. When a plurality of types of abnormal patterns exists in abnormal data, there may be a case where the number of pieces of data of an abnormal pattern is sufficient while the number of pieces of data of another abnormal pattern is extremely small. In such a case, the identification performance for the abnormal pattern that is small in the number of data decreases.

Thus, in the present exemplary embodiment, the information processing apparatus prompts the user to add data necessary for improving the identification performance by use of the data distribution on the feature space and the likelihood L(cᵢ). The information processing apparatus enables the user to select abnormal data 104 close to normal data from the visualized result and confirm data to be added, as illustrated in FIG. 1. Further, the information processing apparatus can display additional data and a trend of the data without requiring user selection. Points in which the present exemplary embodiment is different from the second exemplary embodiment will be described below.

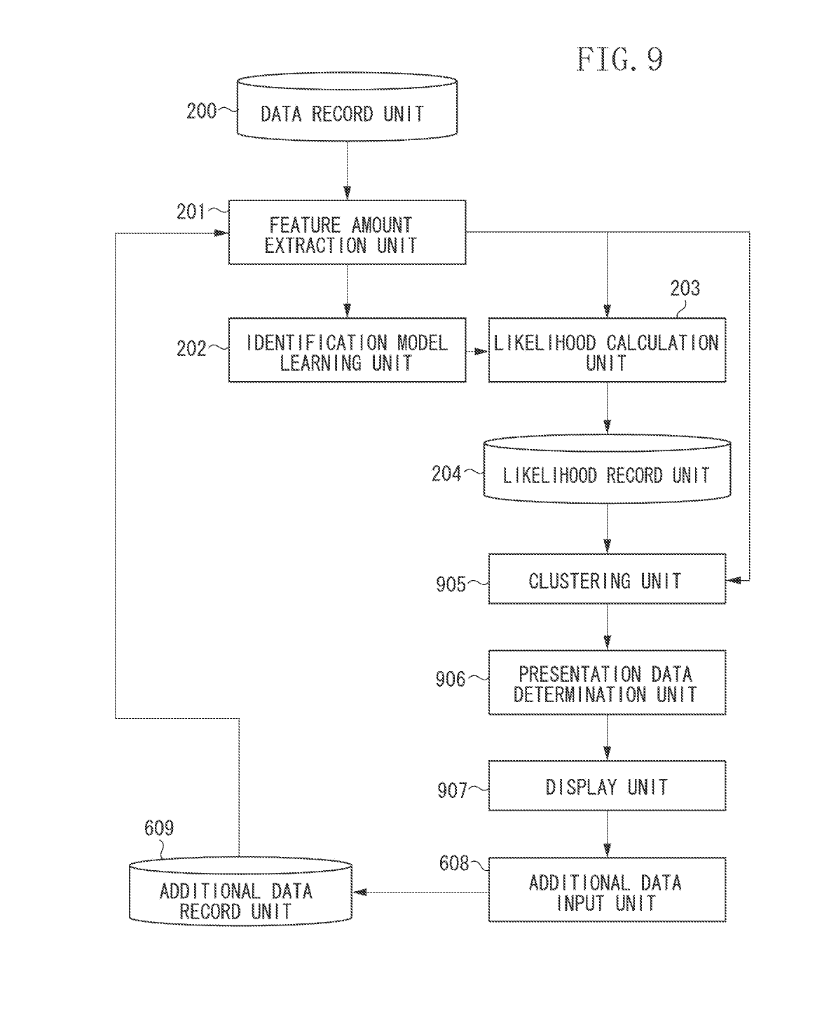

FIG. 9 is a block diagram illustrating an example of a configuration of the information processing apparatus according to the third exemplary embodiment of aspects of the present invention. The information processing apparatus illustrated in FIG. 9 is different from the information processing apparatus illustrated in FIG. 6 in that an additional data input unit 608 and an additional data record unit 609 are provided in place of the label correction unit 908.

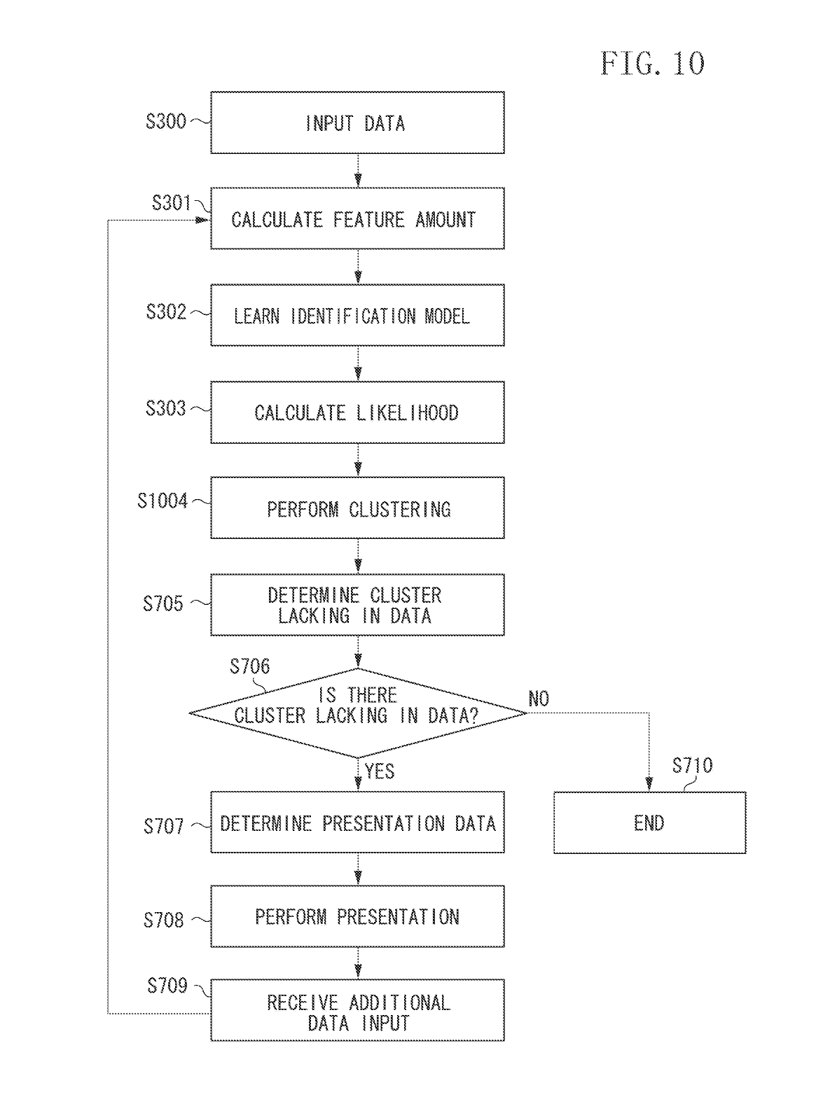

FIG. 10 is a flow chart illustrating a method of information processing performed by the information processing apparatus according to the present exemplary embodiment. In steps S300 to S303 and S1004, the information processing apparatus performs processing similar to those in the second exemplary embodiment (FIG. 7). More specifically, in step S300, the feature amount extraction unit 201 inputs data stored in the data record unit 200. Next, in step S301, the feature amount extraction unit 201 calculates a feature amount cᵢ for data stored in the data record unit 200. Next, in step S302, the identification model learning unit 202 learns using the calculated feature amount cᵢ an identification model for the identification between normal and abnormal. Next, in step S303, the likelihood calculation unit 203 calculates using the identification model a likelihood L(cᵢ) for the feature amount cᵢ calculated by the feature amount extraction unit 201. The likelihood record unit 204 stores the likelihood L(cᵢ). Next, in step S1004, the clustering unit 905 classifies a plurality of pieces of data into k pieces of clusters B1 to Bk by data clustering using the likelihood L(cᵢ) and the feature amount cᵢ.

Next, in step S705, the presentation data determination unit 906 assigns labels that occur most frequently in the clusters B1 to Bk, respectively, as labels of the clusters B1 to Bk, respectively. Then, the presentation data determination unit 906 determines from a result of the clustering performed by the clustering unit 905 a cluster lacking in data for leaning the identification model. Then, the presentation data determination unit 906 determines data to be presented to the user as similar data of the cluster lacking in data from the cluster lacking in data.

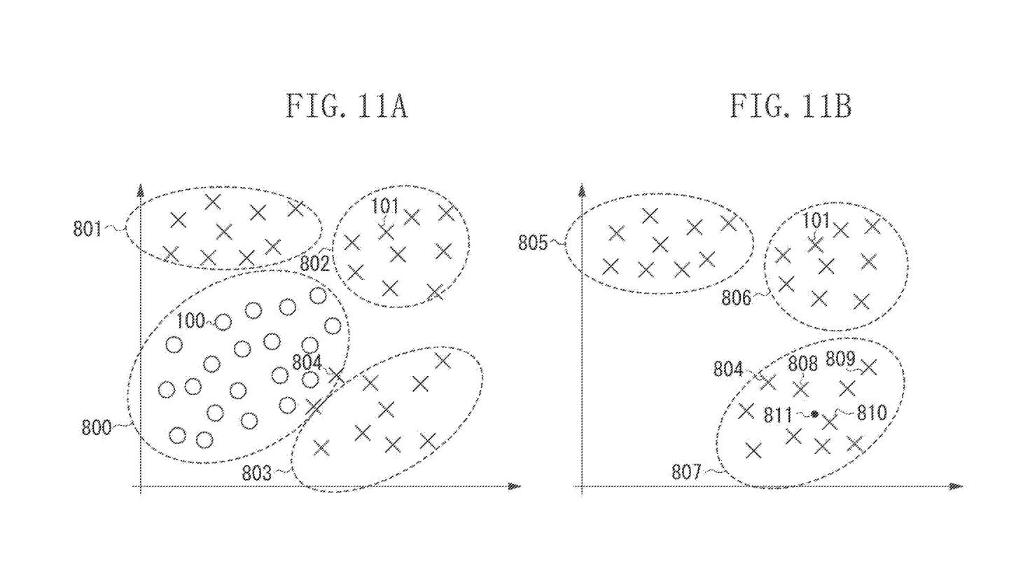

FIG. 11A is a diagram illustrating an example of a clustering result. The clustering unit 905, for example, classifies a plurality of pieces of data into clusters 800 to 803. The presentation data determination unit 906, for example, assigns a normal label to the cluster 800, which contains a large number of pieces of normal data 100, and assigns an abnormal label to the clusters 801, 802, and 803, each of which contains a large number of pieces of abnormal data 101.

The presentation data determination unit 906 determines a cluster lacking in data for the learning of the identification model. For example, the presentation data determination unit 906 determines as a cluster lacking in data the cluster 800 to which the normal label is assigned and that contains abnormal data 804. In the cluster 800, the identification between normal and abnormal is not adequately conducted, and there exists abnormal data 804 causing the identification accuracy to decrease. The cluster 800 contains a large number of pieces of normal data 100 and a small number of pieces of abnormal data 804. The abnormal data 804 classified into the cluster 800 to which the normal label is assigned is data causing the identification performance to decrease. The presentation data determination unit 906 determines the cluster 800 to which the abnormal data 804 belongs as a cluster lacking in data.

In order to determine a cluster lacking in data, the presentation data determination unit 906 is to set the normal cluster 800 to which a large number of pieces of normal data 100 belong. Thus, the presentation data determination unit 906 determines as a normal cluster the cluster 800 to which the largest number of pieces of normal data 100 belong. In the present exemplary embodiment, it is assumed that there is one normal cluster among all the clusters. However, there may be a case where two or more normal clusters exist. In such a case, two or more normal clusters may be set. For example, a cluster to which a large number of pieces of normal data belong among 80 or higher percent of the total number of pieces of normal data may be determined as a normal cluster.

Next, the presentation data determination unit 906 extracts the abnormal data 804 belonging to the normal cluster 800. More specifically, the presentation data determination unit 906 extracts the data 804 belonging to the abnormal label having a smaller number of pieces of data than other normal labels, among the pieces of data belonging to the cluster 800. Then, the presentation data determination unit 906 determines as a cluster lacking in data the normal cluster 800 to which the extracted abnormal data 804 belongs.

Next, in step S706, if there is no cluster lacking in data (NO in step S706), the processing is ended in step S710. On the other hand, if there is a cluster lacking in data (YES in step S706), the processing proceeds to step S707.

In step S707, the presentation data determination unit 906 determines the abnormal data 804 extracted in step S705 as presentation data. The abnormal data 804 extracted in step S705 is the data determined as belonging to the normal cluster 800. Thus, the abnormal data 804 has a small difference from the normal data. When the abnormal data 804 having a small difference from the normal data is presented to the user, it is difficult for the user to judge data that is appropriate as additional data. In order to present a trend of additional data as appropriate to the user, data is presented apart from the normal cluster 800 and simultaneously present data from which the user can clearly understand a difference. By presenting the abnormal data 804 together with the data from which the user can understand a difference with ease, it becomes possible to prompt the user to add data that is effective for improving the identification performance.

As to the presentation data, data that has the same abnormal pattern as that of the extracted abnormal data 804 and is located apart from the normal cluster 800 may be needed. In order to select such data, the cluster 803 to which the abnormal data 804 is supposed to belong is determined. Thus, the presentation data determination unit 906 performs clustering of abnormal data excluding normal data from all the data illustrated in FIG. 11A and generates abnormal data clusters 805 to 807 as illustrated in FIG. 11B. Next, the presentation data determination unit 906 determines the abnormal data cluster 807 to which the extracted abnormal data 804 belongs as a cluster to which the extracted abnormal data 804 is supposed to belong. Then, the presentation data determination unit 906 determines data to be presented other than the extracted abnormal data 804 from the abnormal data belonging to the abnormal data cluster 807. Abnormal data 808 located in the neighborhood of the extracted abnormal data 804 among the data belonging to the abnormal data cluster 807 may be presented as presentation data. In this way, a plurality of pieces of similar data can be presented to present to the user more information about data that needs to be added. Further, as another method, abnormal data 809 located at a great distance from the extracted abnormal data 804, abnormal data 810 close to the center of gravity 811 of the abnormal data cluster 807, etc. in the same abnormal data cluster 807 may be determined as presentation data. Any selection method may be used by which data that can provide more information to the user can be selected.

Further, not only the abnormal data cluster 807 to which the extracted data 804 belongs but also data belonging to another abnormal data cluster 806 located in the neighborhood may be determined as presentation data. In this case, as a comparison, presentation data is determined as data of the cluster 806 different from the abnormal data cluster 807 that requires additional data. By presenting such data, the difference from originally needed data becomes clearer to the user.

In the present exemplary embodiment, the cluster 807 to which the extracted abnormal data 804 is supposed to belong is determined by the clustering. As to other methods, for example, if a label other than the normal label and the abnormal label is assigned as input data, the cluster to which the extracted abnormal data is supposed to belong may be determined using the label information.

Next, in step S708, the display unit 907 displays (presents) to the user the position of the positional coordinates of the presentation data containing the abnormal data 804 extracted by the presentation data determination unit 606 on the space and prompts the user to input additional data.

Next, in step S709, the additional data input unit 608 receives input of additional data from the user. In the present exemplary embodiment, the user inputs data close to the abnormal data 804 displayed by the display unit 607. The additional data record unit 609 stores the input data in the format illustrated in FIG. 4. Thereafter, the processing returns to step S301, and the information processing apparatus repeats the learning of the identification model again using the data stored in the data record unit 200 and the additional data record unit 609. In other words, if data is added based on the display by the display unit 607, the feature amount extraction unit 201 extracts a feature amount cᵢ from the added input data, and the identification model learning unit 202 learns the identification model using the feature amount cᵢ of the added data. In this way, the identification model is learned with the additional data taken into consideration so that the likelihood L(cᵢ) that is the identification criterion can be calculated more appropriately and the clustering is performed as appropriate. For example, as illustrated in FIG. 11B, the appropriate abnormal data cluster 807 to which the abnormal data 804 belongs can be generated.

In the present exemplary embodiment, in step S706, the processing is repeated until the presentation data determination unit 906 determines that there is no cluster lacking in data. Further, if the user selects not to input additional data, the processing proceeds to step S710 to end the processing.

As the foregoing describes, in the present exemplary embodiment, the clustering is performed using the likelihood L(cᵢ), which is an identification criterion, in addition to the feature amount cᵢ of data so that the influence of the identification model can be taken into consideration to present to the user the image data that is effective as additional data.

In the first to third exemplary embodiments, the data distribution on the feature space and the likelihood that is the identification criterion can be displayed simultaneously even in the case where feature amounts of four or greater dimensions are used. Further, in the second and third exemplary embodiments, data that is effective for improving the identification performance can be presented to the user based on the data distribution on the feature space and the likelihood that is the identification criterion.

The foregoing exemplary embodiments are mere illustration of examples of implementation of aspects of the present invention, and the interpretation of the technical scope of aspects of the present invention should not be limited by the disclosed exemplary embodiments. In other words, aspects of the present invention can be implemented in various forms without departing from the spirit features thereof.

### OTHER EMBODIMENTS

Embodiment(s) of aspects of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-204016, filed Oct. 15, 2015, which is hereby incorporated by reference herein in its entirety.

What is claimed is:

1. An apparatus comprising:
an extraction unit configured to extract a feature amount from each of a plurality of pieces of input data;
a calculation unit configured to calculate, based on an identification model for identifying to which one of a plurality of labels each of the plurality of pieces of input data belongs, which is generated using the feature amount, a likelihood indicating how likely each of the plurality of pieces of input data belongs to the labels; and
a presenting unit configured to present attribute information about the input data based on the feature amount and the likelihood.

2. The apparatus according to claim 1, further comprising a processing unit configured to calculate positional coordinates of each of the plurality of pieces of input data on a space based on the feature amount and the likelihood,
wherein the presenting unit displays, as the attribute information about the input data, a position of the positional coordinates of each of the plurality of pieces of input data on the space.

3. The apparatus according to claim 2, wherein, in a case where the feature amount and the likelihood are data of more than three dimensions, the processing unit reduces a number of dimensions and calculates positional coordinates on a space of three or less dimensions.

4. The apparatus according to claim 2, wherein the processing unit calculates the positional coordinates of each of the plurality of pieces of input data so that an error between a distance between two pieces of the input data regarding the feature amount and the likelihood and a distance between the positional coordinates of the two pieces of the input data on the space is minimized.

5. The apparatus according to claim 4, wherein the processing unit calculates the positional coordinates using a vector obtained by combining the feature amount and the likelihood.

6. The apparatus according to claim 2, wherein the presenting unit displays, as the attribute information about the input data, a contour line indicating positional coordinates of a same likelihood.

7. The apparatus according to claim 1, wherein the calculation unit calculates, using a mean value of feature amounts of a plurality of pieces of input data belonging to a first label, a likelihood indicating how likely each of the plurality of pieces of input data belongs to the first label.

8. The apparatus according to claim 1, further comprising:
a clustering unit configured to classify the plurality of pieces of input data into a plurality of clusters using the feature amount and the likelihood; and
a determination unit configured to determine, as presentation data, input data belonging to a label having a smaller number of pieces of input data than other labels, among input data belonging to the clusters,
wherein the presenting unit presents the presentation data as the attribute information about the input data.

9. The apparatus according to claim 8,
wherein the clustering unit calculates positional coordinates of each of the plurality of pieces of input data on the space based on the feature amount and the likelihood, and
wherein the presenting unit displays, as the attribute information about the input data, a position of positional coordinates of the presentation data on the space.

10. The apparatus according to claim 9, further comprising:
a correction unit configured to correct a label to which the presentation data belongs in a case where an instruction to correct the label to which the presentation data displayed by the presenting unit belongs is issued; and
a learning unit configured to learn the identification model using the presentation data of the corrected label.

11. The apparatus according to claim 9,
wherein, in a case where input data is added based on a display by the presenting unit, the extraction unit extracts a feature amount from the added input data, and
wherein the apparatus further comprises a learning unit configured to learn the identification model using the feature amount of the added input data.

12. A method comprising:
extracting a feature amount from each of a plurality of pieces of input data;
calculating, based on an identification model for identifying to which one of a plurality of labels each of the plurality of pieces of input data belongs, which is generated using the feature amount, a likelihood indicating how likely each of the plurality of pieces of input data belongs to the labels; and
presenting attribute information about the input data based on the feature amount and the likelihood.

13. The method according to claim 12, further comprising:
calculating positional coordinates of each of the plurality of pieces of input data on a space based on the feature amount and the likelihood; and
displaying, as the attribute information about the input data, a position of the positional coordinates of each of the plurality of pieces of input data on the space.

14. The method according to claim 12, wherein the calculating calculates, using a mean value of feature amounts of a plurality of pieces of input data belonging to a first label, a likelihood indicating how likely each of the plurality of pieces of input data belongs to the first label.

15. The method according to claim 12, further comprising:
classifying the plurality of pieces of input data into a plurality of clusters using the feature amount and the likelihood; and
determining, as presentation data, input data belonging to a label having a smaller number of pieces of input data than other labels, among input data belonging to the clusters,
wherein the presenting presents the presentation data as the attribute information about the input data.

16. A storage medium storing a program that causes a computer to function as each unit of an apparatus, the apparatus comprising:
an extraction unit configured to extract a feature amount from each of a plurality of pieces of input data;
a calculation unit configured to calculate, based on an identification model for identifying to which one of a plurality of labels each of the plurality of pieces of input data belongs, which is generated using the feature amount, a likelihood indicating how likely each of the plurality of pieces of input data belongs to the labels; and
a presenting unit configured to present attribute information about the input data based on the feature amount and the likelihood.

17. The storage medium according to claim 16,
wherein the apparatus further comprises a processing unit configured to calculate positional coordinates of each of the plurality of pieces of input data on a space based on the feature amount and the likelihood, and
wherein the presenting unit displays, as the attribute information about the input data, a position of the positional coordinates of each of the plurality of pieces of input data on the space.

18. The storage medium according to claim 16, wherein the calculation unit calculates, using a mean value of feature amounts of a plurality of pieces of input data belonging to a first label, a likelihood indicating how likely each of the plurality of pieces of input data belongs to the first label.

19. The storage medium according to claim 16, wherein the apparatus further comprising:
a clustering unit configured to classify the plurality of pieces of input data into a plurality of clusters using the feature amount and the likelihood; and
a determination unit configured to determine, as presentation data, input data belonging to a label having a smaller number of pieces of input data than other labels, among input data belonging to the clusters,
wherein the presenting unit presents the presentation data as the attribute information about the input data.
